(19) United States
(12) Patent Application Publication
(10) Pub. No.: US 2026/0062571 A1
(43) Pub. Date: Mar. 5, 2026

(54) FUNCTIONAL FILM FORMING METHOD

(71) Applicant: SEIKO EPSON CORPORATION, Tokyo (JP)

(72) Inventors: Masaya ISHIDA, HARA-MURA (JP); Takayoshi KAGATA, SHIOJIRI-SHI (JP); Kenta KIKUCHI, SUWA-SHI (JP)

(21) Appl. No.: 19/311,141

(22) Filed: Aug. 27, 2025

(30) Foreign Application Priority Data
Aug. 29, 2024 (JP) 2024-147337

(51) Int. Cl. C09D 11/30; B41M 7/00; C09D 11/033

(52) U.S. Cl. CPC C09D 11/30; B41M 7/009; C09D 11/033

(57) ABSTRACT

A functional film forming method includes: a preparation step of preparing a liquid containing an organic amine compound, a functional material, and a solvent containing water, a content of the organic amine compound being 0.02 mass % or more and 0.40 mass % or less with respect to a total mass; an application step of applying the liquid to a medium by an inkjet method; and a removal step of removing the solvent and the organic amine compound from the liquid applied to the medium.

The present application is based on, and claims priority from JP Application Serial Number 2024-147337, filed Aug. 29, 2024, the disclosure of which is hereby incorporated by reference herein in its entirety.

### BACKGROUND

### 1. Technical Field

The present disclosure relates to a functional film forming method.

### 2. Related Art

In related art, there has been known a method for forming various films by applying a liquid to a medium using an inkjet method. The liquid may contain a pH adjuster such as an organic amine compound. For example, JP-A-2021-105082 discloses an inkjet ink containing an organic amine such as triethanolamine or triisopropanolamine.

JP-A-2021-105082 is an example of the related art.

However, the ink disclosed in JP-A-2021-105082 has a problem in that it is difficult to improve quality of a functional film when the ink is applied to formation of the functional film. Specifically, triethanolamine and triisopropanolamine have a relatively high boiling point and are likely to remain in the film formed by the ink. Therefore, when the ink is used for forming the functional film, the quality of the functional film may deteriorate due to the remaining organic amine. On the other hand, when an ink with no pH adjuster is used, there is also a problem that an inkjet head member easily deteriorates. That is, there is a demand for a functional film forming method that prevents deterioration of an inkjet head member and improves functional film quality.

### SUMMARY

A functional film forming method includes: a preparation step of preparing a liquid containing an organic amine compound, a functional material, and a solvent containing water, a content of the organic amine compound being 0.02 mass % or more and 0.40 mass % or less with respect to a total mass; an application step of applying the liquid to a medium by an inkjet method; and a removal step of removing the solvent and the organic amine compound from the liquid applied to the medium.

### BRIEF DESCRIPTION OF THE DRAWINGS

FIG. 1 is a table showing compositions and pH of functional material liquids according to Experiment 1.

FIG. 2 is a table showing compositions and pH of functional material liquids according to Experiment 2.

### DESCRIPTION OF EMBODIMENTS

A functional film forming method according to an embodiment includes a preparation step, an application step, and a removal step. The functional film forming method of the embodiment is an example, and the disclosure is not limited thereto.

### 1. Preparation Step

In the preparation step, a liquid to be a material of a functional film is prepared. The liquid contains a solvent containing water, a functional material, and an organic amine compound. Here, in the following description, the liquid serving as the material of the functional film is also referred to as a functional material liquid.

Water is a main solvent of the functional material liquid. That is, the functional material liquid is aqueous. Water is a component that volatilizes after the functional material liquid adheres to a medium to be described later. As water, it is possible to use pure water such as ion-exchanged water, ultrafiltered water, reverse osmosis water, and distilled water, and water from which ionic impurities are removed as much as possible, such as ultrapure water. In addition, when water sterilized by ultraviolet irradiation, hydrogen peroxide addition, or the like is used, generation of mold or bacteria is prevented when the functional material liquid is stored for a long time. A water content in the functional material liquid is appropriately adjusted according to a type of the functional film formed by the functional material liquid, a material of the medium, characteristics of an inkjet head applied in the application step, and the like.

The functional material liquid may contain a solvent other than water. Examples of the solvent other than water include: 1,2-alkanediols such as 1,2-propanediol, 1,2-butanediol, 1,2-pentanediol, and 1,2-hexanediol; polyhydric alcohols such as ethylene glycol, diethylene glycol, triethylene glycol, propylene glycol, dipropylene glycol, 1,3-propanediol, 1,3-butanediol, 1,3-pentanediol, 1,4-butanediol, 1,5-pentanediol, 1,6-hexanediol, 2,3-butanediol, 3-methyl-1,3-butanediol, 3-methyl-1,5-pentanediol, 2-methyl-1,3-propanediol, 2,2-dimethyl-1,3-propanediol, 2-methyl-2,4-pentanediol, and glycerin; glycol ethers such as alkylene glycol monoether and alkylene glycol diether; and carbonate-based solvents.

A content of the organic solvent in the functional material liquid is appropriately adjusted according to the type of the functional film formed by the functional material liquid, the material of the medium, the characteristics of the inkjet head applied in the application step, and the like.

The functional material is responsible for functionality of the functional film formed by the functional material liquid. The functional material is selected according to an application and a purpose of the functional film. The application of the functional film is not particularly limited, and examples thereof include a fuel cell and a solar cell.

Examples of the functional material for the fuel cell application include a material for forming a polymer electrolyte membrane, such as a tetrafluoroethylene-perfluoro[2-(fluorosulfonylethoxy)propyl vinyl ether] copolymer. The material for forming the polymer electrolyte membrane is also applicable to an ion exchange membrane and hydrogen production.

Examples of the functional material for the solar cell application include a conductive polymer such as a mixture of poly(3,4-ethylenedioxythiophene) (PEDOT) and polyanion poly(styrenesulfonate) (PSS). The conductive polymer is also applicable to a solid electrolytic capacitor, an antistatic film, a light emitting device, and the like.

A content of the functional material in the functional material liquid is appropriately adjusted according to the type of the functional film formed by the functional material liquid, a desired thickness of the functional film, and the like.

The functional material may be dissolved or dispersed in the functional material liquid. Among the functional materials described above, those having a substituent such as a sulfo group in a molecular structure exhibit acidity when dissolved or dispersed in water. That is, such a functional material liquid becomes acidic.

A plurality of types of members are used for an inkjet head applied in an inkjet method. Among these members, there may be a member easily deteriorated by an acidic liquid. Therefore, it is preferable that a so-called pH adjuster is contained in the functional material liquid to increase pH of the functional material liquid.

Examples of the pH adjuster include an inorganic base and an organic base. Among these pH adjusters, those having a metal element are difficult to be removed from the formed functional film. When the metal element remains in the functional film, there is a concern that quality improvement in the above applications may be hindered. In this regard, in the functional film forming method of the embodiment, the organic amine compound is applied as the pH adjuster, and the organic amine compound is removed in the removal step.

The organic amine compound functions as the pH adjuster in the functional material liquid and increases the pH of the functional material liquid to reduce a degree of acidity. Examples of the organic amine compound include pyrrolidine, piperidine, pyridine, morpholine, and 4-methylmorpholine, and one or more of these are applied to the functional material liquid. These organic amine compounds have a relatively large acid dissociation constant and have a strong effect of adjusting the functional material liquid to an alkaline side. In addition, removal in the removal step is facilitated due to characteristics of the respective organic amine compounds, such as a boiling point and a vapor pressure at 20° C. In the specification, the boiling point refers to a standard boiling point.

As the organic amine compound, a derivative of pyrrolidine, piperidine, or pyridine, or a derivative of morpholine other than 4-methylmorpholine may be used. As the organic amine compound, aziridine, 2-pyrrolidone, 3-pyrrolidone, ε-caprolactam, or the like may be used.

An organic amine compound, which has a vapor pressure of 0.9 kPa or more and 10.0 kPa or less at 20° C. when the organic amine compound is removed by reducing a pressure in the removal step to be described later, is used. Examples of such an organic amine compound include pyrrolidine (6.51 kPa), piperidine (3.07 kPa), morpholine (1.06 kPa), 4-methylmorpholine (2.40 kPa), and pyridine. Numerical values in parentheses added to the above compound names are vapor pressures at 20° C.

An organic amine compound, which has a boiling point of 80° C. or higher and 150° C. or lower when the organic amine compound is removed by heating in the removal step to be described later, is used. Examples of such an organic amine compound include pyrrolidine (89° C.), piperidine (106° C.), pyridine (115° C.), morpholine (129° C.), 4-methylmorpholine (114° C.), 2-methylpyrazine (135° C.), N-methylmorpholine (116° C.), and 4-ethylmorpholine (139° C.). Numerical values in parentheses added to the above compound names are boiling points.

A content of the organic amine compound in the functional material liquid is 0.02 mass % or more and 0.40 mass % or less with respect to a total mass of the functional material liquid. When the content of the organic amine compound is within the above range, a function as the organic amine compound is exhibited, and an excessive increase in the pH of the functional material liquid is prevented. In particular, by adding an appropriate amount of the organic amine compound in the above range, dispersion stability of the functional material in the functional material liquid is easily secured.

As other components, additives such as a surfactant, a resin emulsion, and a humectant may be applied to the functional material liquid. Known additives can be used as these additives.

In preparation of the functional material liquid, the above components are mixed in any order. Thereafter, filtration is performed as necessary to remove impurities, foreign substances, and the like. As a method for mixing the components, a method of adding the components to a container including a stirring device, such as a mechanical stirrer, a magnetic stirrer, or an ultrasonic stirrer, followed by stirring and mixing is used. As a filtration method, a known method such as centrifugal filtration or filter filtration can be used. The functional material liquid may be degassed using a vacuum pump or the like. When degassing is performed, a degree of vacuum is controlled such that the organic amine compound is not removed from the functional material liquid. Although not particularly limited, for example, the degree of vacuum at 20° C. is 10.0 kPa or more.

The pH of the functional material liquid is preferably adjusted by the organic amine compound. Preferable pH of the functional material liquid is appropriately set according to a member or equipment such as the inkjet head used in the functional film forming method. The pH of the functional material liquid can be measured using a commercially available measurement device.

A numerical value of surface tension of the functional material liquid at 25° C. is preferably 10 mN/m or more and 40 mN/m or less, and more preferably 20 mN/m or more and 40 mN/m or less. Accordingly, stability of ejection from the inkjet head is improved. The surface tension of the functional material liquid can be measured using an automatic surface tensiometer CBVP-Z manufactured by Kyowa Interface Science Co., Ltd.

From the same viewpoint as the surface tension, a numerical value of viscosity of the functional material liquid at 20° C. is preferably 2 millipascal-seconds (mPa·s) or more and 15 mPa·s or less, and more preferably 2 mPa·s or more and 5 mPa·s or less. The viscosity of the functional material liquid can be measured using a viscoelasticity tester MCR-300 manufactured by Pysica. Specifically, the viscosity of the functional material liquid at 20° C. is obtained by adjusting a temperature of the functional material liquid to 20° C., increasing a shear rate from 10 to 1000, and reading the viscosity when the shear rate is 200.

The characteristics and characteristic values of the functional material liquid described above are examples, and the disclosure is not limited thereto.

### 2. Application Step

In the application step, the functional material liquid is applied to the medium using the inkjet method. The inkjet method is a method of ejecting droplets from a nozzle and adhering the droplets to the medium using a change in a volume of a liquid storage chamber in the inkjet head.

A known device such as an inkjet printer can be applied to the inkjet method. Specific examples of the inkjet printer include an on-carriage type or off-carriage type serial printer and a line-head printer.

The inkjet head includes an actuator that is a drive unit. Examples of the actuator include a piezoelectric element using deformation of a piezoelectric body, an electromechanical transducer using displacement of a diaphragm caused by electrostatic attraction, and an electrothermal transducer using bubbles generated by heating.

In the application step, any pattern can be formed at a surface of the medium by moving the inkjet head relative to the medium.

The medium where the functional material liquid adheres is appropriately selected according to use of the functional film. Examples of the medium include an inorganic substrate made of quartz, silicon, ceramic, or the like, a resin sheet or plate made of polyvinyl chloride, polyethylene, polypropylene, and polyethylene terephthalate, a plate made of a metal or an alloy such as iron, silver, copper, and aluminum, and a fabric made of natural fibers or chemical fibers.

### 3. Removal Step

In the removal step, the solvent and the organic amine compound are volatilized and removed from the functional material liquid adhering to the medium to form the functional film. As a method for removing the solvent and the organic amine compound, pressure reduction or heating is used.

When pressure reduction is used as the removal method, an external pressure of the applied functional material liquid, that is, an atmosphere pressure, is reduced to be lower than vapor pressures of the solvent containing water and the organic amine compound. Accordingly, evaporation of the solvent and the organic amine compound from the applied functional material liquid proceeds. According to this method, since heat is hardly applied to the functional film, deterioration of the functional film due to heat is prevented. In addition, when an organic amine compound having a vapor pressure in a range of 0.9 kPa or more and 10.0 kPa or less at 20° C. is used, a time required for removing these can be reduced.

Pressure reduction conditions such as the value of the external pressure and the time for reducing the pressure are appropriately set based on electrical characteristics of the formed functional film, analysis of residual components in the functional film, or the like. Examples of the analysis of the residual components include gas chromatography-mass spectrometry of a thermally desorbed gas from the functional film.

In the removal step, the external pressure may be changed stepwise. Specifically, for example, the functional material liquid is first held at an external pressure higher than the vapor pressures of the solvent and the organic amine compound for a certain time, and then held at a pressure lower than the vapor pressures for a certain time. In addition, when the external pressure is reduced from an atmospheric pressure, a lowest vapor pressure among the vapor pressures of the solvent or the organic amine compound at 20° C. may be relatively quickly reached, and the external pressure may be reduced relatively slowly after reaching the lowest vapor pressure.

In the removal step, a degassing tank that can accommodate and seal the medium and a pressure reduction device such as a vacuum pump are used. Known devices and commercially available products can be applied thereto.

When heating is used as the removal method, an atmosphere temperature of the applied functional material liquid is increased to be higher than boiling points of the solvent containing water and the organic amine compound. Accordingly, evaporation of the solvent and the organic amine compound from the applied functional material liquid proceeds. According to this method, since the heating can be implemented with a relatively simple device, the removal step can be simplified. In addition, the solvent and the organic amine compound can be removed by a process in relatively short time.

Heating conditions such as the atmosphere temperature and a heating time are appropriately set based on the electrical characteristics of the formed functional film, the analysis of the residual components in the functional film, or the like.

In the removal step, the atmosphere temperature may be changed stepwise. Specifically, for example, the functional material liquid may be first held at an atmosphere temperature lower than the boiling points of the solvent and the organic amine compound for a certain time, then the atmosphere temperature may be increased to be higher than the boiling points and the functional material liquid may be held for a certain time.

In the removal step, the above-described pressure reduction and heating may be used in combination. The pressure reduction and heating may be performed in parallel or sequentially. In addition, post-processing or post-treatment may be performed on the medium where the functional film is formed.

According to the embodiment, the following effects can be obtained.

It is possible to prevent deterioration of the inkjet head member and to improve functional film quality. Specifically, since the organic amine compound is contained in the above-described range, the pH of the functional material liquid is adjusted and the deterioration of the inkjet head member is prevented. In addition, since the solvent and the organic amine compound are removed, a component that does not contribute to the functionality of the functional film is reduced. Accordingly, it is possible to provide a functional film forming method that prevents deterioration of the inkjet head member and improves the functional film quality.

### 4. Examples

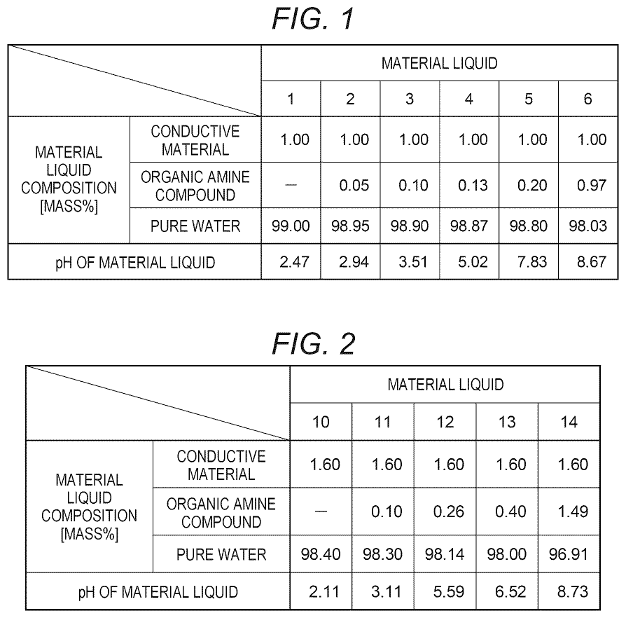

Hereinafter, the effects of the above-described embodiment will be described in more detail with reference to Examples and Comparative Examples. In the Examples, the following Experiments 1 to 3 were performed. In the table in FIG. 1 and the table in FIG. 2 corresponding to Experiment 1 and Experiment 2, notation of “-” in a composition column of the functional material liquid means that a component is not contained.

In Experiment 1, a tetrafluoroethylene-perfluoro[2-(fluorosulfonylethoxy)propyl vinyl ether] copolymer was used as the functional material, and 4-methylmorpholine was used as the organic amine compound.

Specifically, as the preparation step, functional material liquids 1 to 6 were prepared according to compositions in FIG. 1. Next, pH of each of the functional material liquid 1 to the functional material liquid 6 was measured using a pH meter LAQUA (registered trademark) F-74 manufactured by HORIBA, Ltd., and numerical values were recorded in a pH column of each functional material liquid. Among the functional material liquids 1 to 6, a functional material liquid 4 containing 0.13 mass % of the organic amine compound was designated as Example 1, and the functional material liquid 1 not containing the organic amine compound was designated as Comparative Example 1.

Thereafter, in Example 1 and Comparative Example 1, in order to examine an influence on the inkjet head member, resistance was examined for each functional material liquid using an inkjet head S800 manufactured by Seiko Epson Corporation.

Specifically, functional material liquids of Example 1 and Comparative Example 1 were individually charged into an ink storage container, the ink storage container and the inkjet head were connected by a tube, and the inkjet head was filled with each functional material liquid. Next, the inkjet head was operated to print a nozzle check pattern. Accordingly, it was confirmed that nozzles for ejecting Example 1 and Comparative Example 1 normally eject droplets.

In the above state, that is, in a state where each functional material liquid was filled in the inkjet head, the inkjet head was left to stand under an atmosphere of about 25° C. A standing time was gradually extended to 30 minutes, 1 hour, 2 hours, 3 hours, 4 hours, 5 hours, 1 day, 3 days, 1 week, and 2 weeks, and a nozzle check was performed at each timing in the same manner as described above.

As a result, in the functional material liquid 4 in Example 1, all nozzles ejected normally for two weeks or longer. Meanwhile, in the functional material liquid 1 in Comparative Example 1, non-ejecting nozzles began to appear from a standing time of 30 minutes, and the number of non-ejecting nozzles increased as the standing time increased.

Next, as the application step, the functional material liquid 4 in Example 1 was applied onto a glass substrate. Specifically, the functional material liquid 4 was printed in a solid pattern of 30 mm square under conditions of a resolution of 1200 ×1200 dots per inch (dpi) and a droplet volume of 10 picoliters (pL).

Next, heating was adopted as the removal step, and the glass substrate was placed in a thermostatic chamber and heated at 120° C. for 15 minutes. Accordingly, water and methylmorpholine were removed, and a functional film not containing these was obtained.

In Experiment 2, a tetrafluoroethylene-perfluoro[2-(fluorosulfonylethoxy)propyl vinyl ether] copolymer was used as the functional material, and morpholine was used as the organic amine compound.

Specifically, as the preparation step, functional material liquids 10 to 14 were prepared according to compositions in FIG. 2. Next, pH of each of the functional material liquid 10 to the functional material liquid 14 was measured in the same manner as in Experiment 1, and numerical values were recorded in a pH column of each functional material liquid. Among the functional material liquid 10 to the functional material liquid 14, a functional material liquid 12 was designated as Example 2, a functional material liquid 13 was designated as Example 3, and the functional material liquid 14 was designated as Example 4.

Thereafter, in Examples 2, 3, and 4, the influence on the inkjet head member was examined in the same manner as in Experiment 1. As a result, in Examples 2, 3, and 4, all nozzles normally ejected ink for two weeks or longer.

In Experiment 3, a mixture of PEDOT and PSS was used as the functional material, and morpholine was used as the organic amine compound.

As the preparation step, a functional material liquid 21 in Example 5 and a functional material liquid 20 in Comparative Example 2 were prepared. The functional material liquid 21 in Example 5 contains 0.80 mass % of the mixture of PEDOT and PSS and 0.02 mass % of morpholine. The functional material liquid 20 in Comparative Example 2 contains 0.80 mass % of the mixture of PEDOT and PSS and does not contain the organic amine compound. As a result of measuring pH of each functional material liquid in the same manner as in Experiment 1, pH of Example 5 was 5.0, and pH of Comparative Example 2 was 3.5.

Thereafter, in Example 5 and Comparative Example 2, the influence on the inkjet head member was examined in the same manner as in Experiment 1. As a result, in the functional material liquid 21 in Example 5, all nozzles ejected ink normally for two weeks or longer. Meanwhile, in the functional material liquid 20 in Comparative Example 2, non-ejecting nozzles began to appear from a standing time of 4 hours, and the number of non-ejecting nozzles increased as the standing time increased.

Next, as the application step, the functional material liquid 21 in Example 5 and the functional material liquid 20 in Comparative Example 2 were each applied onto a glass substrate under the same conditions as in Experiment 1.

Next, pressure reduction was adopted as the removal step, the glass substrate was placed in a vacuum degassing tank and pressure reduction was performed at a degree of vacuum of 100 Pa or less for 10 minutes or longer. From a functional film in Example 5, pure water and morpholine were removed.

Thereafter, conductivity was measured for the functional film in Example 5 and a functional film in Comparative Example 2. Both the functional film in Example 5 and the functional film in Comparative Example 2 had conductivity of 4 ×10⁻³ Ωcm.

Experiments 1, 2, and 3 show that, in the functional material liquid of each Example, deterioration of the inkjet head member is prevented and functional film quality is improved.

What is claimed is:

1. A functional film forming method comprising:
a preparation step of preparing a liquid containing an organic amine compound, a functional material, and a solvent containing water, a content of the organic amine compound being 0.02 mass % or more and 0.40 mass % or less with respect to a total mass;
an application step of applying the liquid to a medium by an inkjet method; and
a removal step of removing the solvent and the organic amine compound from the liquid applied to the medium.

2. The functional film forming method according to claim 1, wherein
a vapor pressure of the organic amine compound at 20°C. is 0.9 kPa or more and 10.0 kPa or less, and
the organic amine compound is removed by reducing a pressure in the removal step.

3. The functional film forming method according to claim 1, wherein
the organic amine compound has a boiling point of 80°C. or higher and 150°C. or lower, and
the organic amine compound is removed by heating in the removal step.

4. The functional film forming method according to claim 1, wherein
the organic amine compound is one or more of pyrrolidine, piperidine, pyridine, morpholine, and 4-methylmorpholine.
